(19) United States
(12) Patent Application Publication
(10) Pub. No.: US 2012/0301712 A1
(43) Pub. Date: Nov. 29, 2012

(54) MOISTURE BARRIER RESINS FOR CORROSION RESISTANT COATINGS

(75) Inventor: Robert G. BAYLESS, Marietta, GA (US)

(73) Assignee: Encap Technologies, LLC

(21) Appl. No.: 13/113,880

(22) Filed: May 23, 2011

(51) Int. Cl. C23F 11/173; B05D 1/02; C09D 129/04; B32B 15/088; C09D 5/08; B05D 1/36; B32B 15/08

(52) U.S. Cl. 428/339; 427/407.1; 427/427.4; 428/457; 524/503

(57) ABSTRACT

A composition for preparing a corrosion resistant coating for a bulk substrate, said composition comprising: a cross-linkable hydrolyzed polymer; and a cross-linking agent, wherein the cross-linking agent is present in an amount sufficient to cross link about 21.8% to 65.4% of the crosslinkable groups in the cross-linkable hydrolyzed polymer. Also, a method of inhibiting corrosion of a bulk substrate comprising: dissolving a cross-linkable hydrolyzed polymer in an organic solvent to generate a cross-linkable hydrolyzed polymer solution; adding a cross-linking agent to said cross-linkable hydrolyzed polymer solution in an amount sufficient to generate a cross-linked hydrolyzed polymer with about 21.8% to 65.4% cross-linked hydroxyl groups; and applying said cross-linked hydrolyzed polymer to said bulk substrate. Also, a coated bulk substrate, comprising: a bulk substrate; a corrosion resistant coating comprising a cross-linked hydrolyzed polymer with about 21.8% to 65.4% cross-linking; wherein said corrosion resistant coating is in contact with at least a portion of a surface of said bulk substrate.

### BACKGROUND

Coatings can be employed for a number of reasons. Product coatings or industrial coatings, for example, are typically applied in a factory on a given metal substrate or product, such as appliances, automobiles, aircraft, and the like, to reduce the susceptibility of the metal substrate or product to corrosion from environmental exposure.

In order to improve the corrosion resistance of a metal substrate, corrosion inhibitive sacrificial components or additives are typically used in coatings applied to the substrate. For example, painting and/or application of enamel are common anti-corrosion treatments. These anti-corrosion treatments work by providing a barrier of corrosion-resistant material between the damaging environment and the substrate material. Aside from cosmetic and manufacturing issues, there can be tradeoffs in mechanical flexibility versus resistance to abrasion and high temperature.

Thus, there is a need for highly corrosion resistant coatings which are also mechanically flexible with superior ability to adhere to the surface of metal substrates. Patent literature includes US Patent Publications 2003/0235690; 2004/0105979; 2004/0130045; 2005/0276991; 2008/0166557; each to Bayless.

### SUMMARY

Compositions, methods of making compositions, and methods of using compositions are described herein. For example, one embodiment provides corrosion resistant coatings and methods for inhibiting corrosion of a substrate with corrosion resistant coatings.

In one aspect, a corrosion resistant coating comprises a cross-linkable hydrolyzed polymer and a cross-linking agent.

In some embodiments, the cross-linkable hydrolyzed polymer has a dielectric constant less than about 2.2.

In some embodiments, the cross-linkable hydrolyzed polymer comprises a hydrolyzable, cross-linkable ethylene-vinyl acetate copolymer; such as partially hydrolyzed poly(ethylene-vinyl acetate).

In some embodiments where the cross-linkable hydrolyzed polymer comprises partially hydrolyzed poly(ethylene-vinyl acetate) related embodiments, the partially hydrolyzed poly(ethylene-vinyl acetate) may comprise about 60 to about 88 mol percent ethylene. In some embodiments, the partially hydrolyzed poly(ethylene-vinyl acetate) is about 38 to about 55 percent hydrolyzed; such as about 44 to about 46 percent hydrolyzed. In other embodiments, the partially hydrolyzed poly(ethylene-vinyl acetate) comprises about 70 percent ethylene, about 10 to about 14 percent vinyl alcohol, and about 16 to about 20 percent vinyl acetate. In some related embodiments, the partially hydrolyzed poly(ethylene-vinyl acetate) comprises about 12.5 to about 13 percent vinyl alcohol. In other related embodiments, the partially hydrolyzed poly(ethylene-vinyl acetate) comprises about 17 to about 18 percent vinyl acetate. In other embodiments, the partially hydrolyzed poly (ethylene-vinyl acetate) comprises vinyl alcohol groups and vinyl acetate groups at a mole ratio of vinyl alcohol groups to the sum of vinyl alcohol groups and the vinyl acetate groups at about 0.15 to about 0.7.

In other embodiments, the cross-linkable hydrolyzed polymer may comprise a poly(vinyl-formal) polymer, a poly(vinyl-butyral) polymer, an alkylated cellulose, or an acylated cellulose; such as ethyl cellulose and/or cellulose acetate butyrate.

In some embodiments, the cross-linking agent comprises one or more of a diisocyanate and a polyisocyanate, with or without a catalyst present. In related embodiments, the cross-linking agent may comprise an aliphatic diisocyanate, a non-aliphatic diisocyanate such as toluene diisocyanate, an aliphatic polyisocyanate, a non-aliphatic polyisocyanate, a toluene diisocyanate-trimethylol propane adduct, and/or a diacid halide, such as a dicarboxylic acid chloride, including adipoyl chloride, terephthaloyl chloride, or phosgene (carbonic dichloride).

In some embodiments, the cross-linkable hydrolyzed polymer and the cross-linking agent are present in solution at a ratio of cross-linkable hydrolyzed polymer to cross-linking agent within the range of about 10:1 to 1:1 by weight; such as within the range of about 5:1 to 4:3 by weight; such as within the range of about 5:1 to 2:1 by weight; such as within the range of about 4:1 to 2:1. Cross-linkable hydrolyzed polymer and cross-linking agent present at these ranges preferably lead to cross linking occurring at a percentage of hydroxyl groups in the polymer within the range of about 8.73% to 87.3%; such as within the range of about 21.8% to 65.4%; such as within the range of about 21.8% to 43.6%, such as within the range of about 21.8 to about 35%, such as within the range of about 21.8 to about 25%.

In some embodiments, the cross-linkable hydrolyzed polymer and the cross-linking agent are present in solution at a ratio of cross-linkable hydrolyzed polymer to cross-linking agent within the range of about 5:1 to 10:3 by weight; such as within the range of about 100:21 to 10:3 by weight; such as within the range of about 100:21 to 4:1 by weight; such as about 4:1. Cross-linkable hydrolyzed polymer and cross-linking agent present at these ranges preferably lead to cross linking occurring at a percentage of hydroxyl groups in the polymer within the range of about 17% to 26%; such as within the range of about 18% to 26%; such as within the range of about 18% to 22%; such as about 22%. In related embodiments, the corrosion resistant coating has a permeance less than about 3.00×10⁻⁷ g/Pa*s*m²; such as less than about 1.00×10⁻⁷ g/Pa*s*m²; such as less than about 5.00×10⁻⁸ g/Pa*s*m²; such as less than about 1.00×10⁻⁸ g/Pa*s*m². In some embodiments, the corrosion resistant coating has a thickness within the range of about 1 to 33 mils; such as within the range of about 5 to 33 mils; such as within the range of about 10 to 33 mils; such as within the range of about 15 to 33 mils.

In a second aspect, methods of inhibiting corrosion of a substrate include the steps of: dissolving a cross-linkable hydrolyzed polymer in an organic solvent to generate a cross-linkable hydrolyzed polymer solution; adding a cross-linking agent to the cross-linkable hydrolyzed polymer solution to generate a cross-linked hydrolyzed polymer solution; and applying the cross-linked hydrolyzed polymer solution to a substrate to form a corrosion inhibiting coating on the substrate.

In some embodiments, the step of applying cross-linked hydrolyzed polymer solution to a substrate comprises applying two or more coats of cross-linked hydrolyzed polymer solution to the substrate. In some embodiments, the step of applying cross-linked hydrolyzed polymer to the substrate comprises spraying cross-linked hydrolyzed polymer solution on the substrate.

In some embodiments, the cross-linkable hydrolyzed polymer has a dielectric constant less than about 2.2.

In some embodiments, the cross-linkable hydrolyzed polymer comprises a hydrolyzable, cross-linkable ethylene-vinyl acetate copolymer; such as partially hydrolyzed poly(ethylene-vinyl acetate).

In some embodiments where the cross-linkable hydrolyzed polymer comprises partially hydrolyzed poly(ethylene-vinyl acetate) related embodiments, the partially hydrolyzed poly(ethylene-vinyl acetate) may comprises about 60 to about 88 mol percent ethylene. In some embodiments, the partially hydrolyzed poly(ethylene-vinyl acetate) is about 38 to about 55 percent hydrolyzed; such as about 44 to about 46 percent hydrolyzed. In other embodiments, the partially hydrolyzed poly(ethylene-vinyl acetate) comprises about 70 percent ethylene, about 10 to about 14 percent vinyl alcohol, and about 16 to about 20 percent vinyl acetate. In some related embodiments, the partially hydrolyzed poly(ethylene-vinyl acetate) comprises about 12.5 to about 13 percent vinyl alcohol. In other related embodiments, the partially hydrolyzed poly(ethylene-vinyl acetate) comprises about 17 to about 18 percent vinyl acetate. In other embodiments, the partially hydrolyzed poly (ethylene-vinyl acetate) comprises vinyl alcohol groups and vinyl acetate groups at a mole ratio of vinyl alcohol groups to the sum of vinyl alcohol groups and the vinyl acetate groups at about 0.15 to about 0.7. In some embodiments, the partially hydrolyzed poly(ethylene-vinyl acetate) has a hydroxyl content of about 204±5% mg KOH/g.

In other embodiments, the cross-linkable hydrolyzed polymer may comprise a poly(vinyl-formal) polymer, a poly(vinyl-butyral) polymer, an alkylated cellulose, or an acylated cellulose; such as ethyl cellulose and/or cellulose acetate butyrate.

In some embodiments, the cross-linking agent comprises one or more of a diisocyanate and a polyisocyanate, with or without a catalyst present. In related embodiments, the cross-linking agent may comprise an aliphatic diisocyanate, a non-aliphatic diisocyanate such as toluene diisocyanate, an aliphatic polyisocyanate, a non-aliphatic polyisocyanate, a toluene diisocyanate-trimethylol propane adduct, and/or a diacid halide, such as a dicarboxylic acid chloride, including adipoyl chloride, terephthaloyl chloride, or phosgene (carbonic dichloride).

In some embodiments, the cross-linkable hydrolyzed polymer and the cross-linking agent are present in solution at a ratio of cross-linkable hydrolyzed polymer to cross-linking agent within the range of about 10:1 to 1:1 by weight; such as within the range of about 4:1 to 4:3 by weight; such as within the range of about 4:1 to 2:1 by weight. Cross-linkable hydrolyzed polymer and cross-linking agent present at these ranges preferably lead to cross linking occurring at a percentage of hydroxyl groups in the polymer within the range of about 8.73% to 87.3%; such as within the range of about 21.8% to 65.4%; such as within the range of about 21.8% to 43.6%, such as within the range of about 21.8% to about 35%, such as within the range of about 21.8 to about 25%.

In some embodiments, the cross-linkable hydrolyzed polymer and the cross-linking agent are present in solution at a ratio of cross-linkable hydrolyzed polymer to cross-linking agent within the range of about 5:1 to 10:3 by weight; such as within the range of about 100:21 to 10:3 by weight; such as within the range of about 100:21 to 4:1 by weight; such as about 4:1. Cross-linkable hydrolyzed polymer and cross-linking agent present at these ranges preferably lead to cross linking occurring at a percentage of hydroxyl groups in the polymer within the range of about 17% to 26%; such as within the range of about 18% to 26%; such as within the range of about 18% to 22%; such as about 22%. In related embodiments, the corrosion resistant coating has a permeance less than about 3.00×10⁻⁷ g/Pa*s*m²; such as less than about 1.00×10⁻⁷ g/Pa*s*m²; such as less than about 5.00×10⁻⁸ g/Pa*s*m²; such as less than about 1.00×10⁻⁸ g/Pa*s*m². In some embodiments, the corrosion resistant coating has a thickness within the range of about 1 to 33 mils; such as within the range of about 5 to 33 mils; such as within the range of about 10 to 33 mils; such as within the range of about 15 to 33 mils.

In some embodiments, the substrate comprises a metal, particularly a metal susceptible to corrosion due to environmental exposure.

### DETAILED DESCRIPTION

As used in this application, the following terms have the indicated definitions:

“Impermeability to moisture” is the ability to substantially prevent passage of moisture through the relevant material.

“Corrosion” refers to degradation of a material or substrate due to chemical reaction with its surroundings. Many metals, including structural alloys, corrode merely from exposure to moisture in the air. Corrosion can be concentrated locally to form a pit or crack, or can extend across a wide exposed area.

“Polymer” refers to a large molecule comprising repeating structural units typically connected by covalent chemical bonds. “Cross-linking” refers to bonding that occurs between two or more polymer molecules. The degree of cross-linking may be expressed stoichiometrically, as the percentage of hydroxyl groups in the polymer that are involved in cross-linking bonds.

“Bulk substrate” refers to a material suitable for coating by the methods or materials described herein. Bulk substrates are not limited in composition, but are limited in size and shape in that bulk substrates are not particulate substrates, such as nanoparticles or microparticles. Certain properties of a coating, such as adhesion, may be different when applied to a bulk substrate as compared to a particulate substrate.

Unless otherwise indicated, the term “about” is used herein to mean in quantitative terms plus or minus 10%.

Unless otherwise indicated, the singular forms “a,” “an,” and “the” include the plural reference.

Each of the references and publications cited herein is incorporated by reference in its entirety.

The present invention relates, in some embodiments, to corrosion resistant resins which are derived from a solution comprising a film-forming, cross-linkable, partially hydrolyzed polymer and a cross-linking agent. When these two reagents are mixed in an appropriate ratio, they form a cross-linked polymer which can be applied to the surface of a variety of corrodible substrates. Thus applied, the cross-linked polymer acts as a moisture barrier, and may be used as a corrosion resistant coating. When applied to the surface of a bulk substrate, the corrosion resistant coatings described herein form films on the surface of the substrate. In some of the examples described below, the corrosion resistant coating have thicknesses are in the range of about 1 to 35 mils (1 mil=0.001 inches). This range is not intended to be limiting, and the coatings may be applied in one or more coats to achieve any desired thickness. For example, corrosion resistant coatings as described herein may have thicknesses of about 1 to about 100 mils, such as about 1 to about 75 mils, such as about 1 to about 50 mils.

In some embodiments, the cross-linkable hydrolyzed polymer and the cross-linking agent are present in solution at a ratio of cross-linkable hydrolyzed polymer to cross-linking agent within the range of about 10:1 to 1:1 by weight; such as within the range of about 4:1 to 4:3 by weight; such as within the range of about 4:1 to 2:1 by weight. Cross-linkable hydrolyzed polymer and cross-linking agent present at these ranges preferably lead to cross linking occurring at a percentage of hydroxyl groups in the polymer within the range of about 8.73% to 87.3%; such as within the range of about 21.8% to 65.4%; such as within the range of about 21.8% to 43.6%; such as within the range of about 21.8 to about 35%; such as within the range of about 21.8 to about 25%.

As seen below in Example 4, certain degrees of cross-linking and certain thickness result in improved moisture impermeability. In embodiments where minimization of moisture permeability is desired, cross-linkable hydrolyzed polymer to cross-linking agent may be present in solution at a ratio within the range of about cross-linkable hydrolyzed polymer to cross-linking agent between about In some embodiments, the cross-linkable hydrolyzed polymer and the cross-linking agent are present in solution at a ratio of cross-linkable hydrolyzed polymer to cross-linking agent within the range of about 5:1 to 10:3 by weight; such as within the range of about 100:21 to 10:3 by weight; such as within the range of about 100:21 to 4:1 by weight; such as about 4:1. Cross-linkable hydrolyzed polymer and cross-linking agent present at these ranges preferably lead to cross linking occurring at a percentage of hydroxyl groups in the polymer within the range of about 17% to 26%; such as within the range of about 18% to 26%; such as within the range of about 18% to 22%; such as about 22%. In related embodiments, the corrosion resistant coating has a permeance less than about 3.00×10⁻⁷ g/Pa*s*m²; such as less than about 1.00×10⁻⁷ g/Pa*s*m²; such as less than about 5.00×10⁻⁸ g/Pa*s*m²; such as less than about 1.00×10⁻⁸ g/Pa*s*m². In some embodiments, the corrosion resistant coating has a thickness within the range of about 1 to 33 mils; such as within the range of about 5 to 33 mils; such as within the range of about 10 to 33 mils; such as within the range of about 15 to 33 mils. In other embodiments where minimization of moisture permeability is desired, the cross-linked corrosion resistant coating may be applied in thicknesses of about 15 mils or greater, such as about 15 mils to about 75 mils, such as about 15 to about 50 mils, such as about 15 mils to about 35 mils.

### The Film-Forming Cross-Linkable, Hydrolyzed Polymer

The polymer should be substantially dielectric, preferably with a dielectric constant less than about 2.2, preferably in the range of from about 1.8 to about 2.2. Various polymers may be utilized to form the cross-linked corrosion resistant coating. A preferred polymer is a hydrolyzable, cross-linkable ethylene-vinyl acetate copolymer. For certain applications, the polymer should be pyrolyzable.

The polymeric material can be any film-forming polymeric material that wets the substrate material. The corrosion resistant coating material preferably is partially hydrolyzed poly(ethylene-vinyl acetate) containing about 60 mol % to about 88 mol % ethylene, in which some of the vinyl acetate groups are hydrolyzed to form vinyl alcohol groups that provide reaction sites for subsequent cross-linking The degree of hydrolysis for the poly (ethylene-vinyl acetate) can be within the relatively broad range of about 38% to about 55%, preferably within the range of about 44% to about 46%.

A preferred film-forming polymer for use in the presently claimed inventions is a poly (ethylene-vinyl acetate) containing about 60 mol % to about 88 mol % ethylene and having about 38% to about 55% (preferably between about 44% and about 46%) of the vinyl acetate groups hydrolyzed to vinyl alcohol groups to provide reaction sites for cross-linking

Thus, the partially hydrolyzed copolymers of ethylene and vinyl acetate contain ethylene groups, vinyl acetate groups, and vinyl alcohol groups, and can be represented by the general formula:

—(CH₂CHOH)_{X} —(CH₂CH₂)_{Y}—(CH₂CHOCOCH₃)_{Z}—

wherein x, y and z represent mol fractions of ethylene, vinyl alcohol and vinyl acetate, respectively. With respect to the degree of hydrolysis, the mol ratio of the vinyl alcohol groups to the sum of vinyl alcohol groups and the vinyl acetate groups present is about 0.15 to about 0.7. The amount of ethylene groups present is also important and can be about 60 to about 88 mol percent. Stated another way, the mol ratio of ethylene groups to the sum of ethylene groups, vinyl alcohol groups and vinyl acetate groups can be about 0.6 to about 0.88.

Generally, the suitable partially-hydrolyzed poly(ethylene-vinyl acetate) has a molecular weight of about 50,000 and a melt index (using a 2160 gram force at 190° C., for 10 minutes) of about 5 to about 70, preferably a melt index of about 35 to about 45. The molecular weight of the copolymer is not overly critical, except that if the molecular weight is too high, the copolymer will be relatively insoluble. Other suitable cross-linkable polymeric materials include poly(vinyl-formal) polymers, poly(vinyl-butyral) polymers, alkylated cellulose (e.g., ethyl cellulose), acylated cellulose (e.g., cellulose acetate butyrate) and the like.

The preferred polymer is poly(ethylene-vinyl acetate) having a melt index of about 35 to about 37 and having about 44% to about 46% of the vinyl acetate groups hydrolyzed to vinyl alcohol groups. This polymer has an ethylene content of about 70%, a vinyl alcohol content of about 10% to about 14% (most preferably about 12.5% to about 13%) and a vinyl acetate content of about 16% to about 20% (most preferably about 17% to about 18%).

### Cross-Linking of the Film-Forming, Cross-Linkable, Hydrolyzed Polymer

Suitable cross-linking agents useful for preparation of the corrosion resistant coatings include the diisocyanates or polyisocyanates, e.g., aliphatic diisocyanates, non-aliphatic diisocyanates such as toluene diisocyanate, aliphatic polyisocyanates, and non-aliphatic polyisocyanates, with or without a catalyst present. Particularly preferred is a toluene diisocyanate-trimethylol propane adduct. Also suitable as cross-linking agents are diacid halides, such as dicarboxylic acid chloride, including adipoyl chloride, terephthaloyl chloride, or phosgene (carbonic dichloride) and the like, as well as difunctional hydrides.

In addition to the addition of one or more of the agents listed above, cross-linking of the polymer may be accomplished by any other method known in the art.

Application of the cross-linking/polymer mixture to a substrate may be accomplished my any method known for applying surface coatings to a bulk substrate; for example, the cross-linking/polymer mixture may be applied to a substrate by dipping, spraying, and the like. Additionally, the corrosion resistant coating may be applied to the substrate in one or more coats. In preferred embodiments, one to three coats are applied to the substrate. In especially preferred embodiments, two coats are applied to the substrate.

Moisture permeability of the corrosion resistant coating is dependent to a considerable extent on the degree of cross-linking that has been effected. However, excessive cross-linking also negatively impacts the adhesion of the coating to the surface of a bulk substrate. The inventors have thus found that to achieve high corrosion resistance and high coating adherence, the preferential ratios of cross-linkable hydrolyzed polymer to cross-linking agent may be less than 1:1 by weight; such as between about 4:1 to 1:1 by weight; such as between about 4:1 and 4:3 by weight; such as between about 4:1 to about 2:1 by weight; such as about 2:1 by weight. Cross-linkable hydrolyzed polymer and cross-linking agent present at these ranges preferably lead to cross linking occurring at a percentage of hydroxyl groups in the polymer within the range of about 43.6% to 87.3%; such as between about 43.6% to 65.4%; such as about 43.6%.

To illustrate two embodiments of the processes of this invention, preparation and application of an exemplary corrosion resistant coating by dipping and by spraying will be discussed. These preparation and application methods are exemplary and the invention is not intended to be limited to these application methods.

In one embodiment, a solution of a film-forming polymeric material comprising partially hydrolyzed ethylene-vinyl acetate copolymer (HEVA), having from about 38% to about 55%, and preferably from about 44% to about 46%, of the vinyl acetate groups hydrolyzed to form vinyl alcohol groups, is prepared in a liquid vehicle such as toluene at an elevated dissolution temperature (e.g., typically above about 70° C., and preferably from about 75° C. to about 100° C.). Once dissolved, this admixture is cooled, and a solution of a cross-linking agent, such as toluene diisocyanate (TDI) adducted with trimethylol propane in toluene, is added and the solution mixed.

The solution prepared above may then be applied to a substrate as a surface coating, for example, by dipping the substrate in the mixture at room temperature. The cross-linked polymeric coating is then allowed to set at room temperature. Multiple coatings may be applied by re-dipping the substrate in the solution. Preferably, each coating is allowed some period of time to set, such as about 10 to 20 minutes, before application of a subsequent coat. Preferably, two coats are applied.

In a second embodiment, a plural-spray or proportional spray system may be used to apply the corrosion resistant coating. Plural-spray or proportional spray systems do not mix the polymeric material and the cross-linking agent until immediately prior to spray application. In one example of use of this type of spray system, a HEVA/tolulene admixture may be prepared as described above, and loaded into the sprayer system. The cross-linking agent may then be loaded into a separate chamber of the sprayer system. Mixing of the two components then only occurs immediately prior to spraying of the coating.

Again, multiple coats may be applied using a plural-spray system, and preferably, each coating is allowed some period of time to set, such as about 10 to 20 minutes, before application of a subsequent coat. Preferably, two coats are applied.

Further illustrations are provided by the following non-limiting examples.

### EXAMPLES

### Example 1

### Cyclic Corrosion Testing of Test Panels Coated with Cross-Linked Polymer (From 1:1 Cross-Linkable Hydrolyzed Polymer:Cross Linking Agent)

Fourteen 1010 cold-rolled steel test panels were prepared with polymer/primer, or polymer/primer/enamel top coat for cyclic corrosion testing. All test panels were first dipped into a cross linked polymer made from hydrolyzed ethylene vinyl acetate (HEVA) (dissolved in toluene at about 10% HEVA by weight) and Desmodur® L 75 (an aromatic polyisocynate cross linking agent by Bayer Material Science) at about a 1:1 ratio by weight, and allowed to dry.

All fourteen panels were then dipped twice in Red Oxide epoxy primer III (Zinc Rich), with each dipping conducted at about 15 minutes apart. Two of the test panels were further dipped twice (again at about 15 minutes apart) in an enamel top coat. All panels were then evaluated with a cyclic corrosion test protocol.

Cyclic exposure testing was conducted according to ASTM D5894-96, Standard Practice for Cyclic Salt Fog/UV Exposure of Painted Metal, (Alternating Exposures in a Fog/Dry Cabinet and a UV/Condensation Cabinet). Three polymer/primer panels were diagonally scribed prior to exposure testing. All test panels were subjected to a cycle of alternating fluorescent UV/condensation and alternating salt fog/drying.

The test panels were first subjected to 168 hours of fluorescent UV/condensation consisting of alternating every four hours between exposure to UV light (UVA 340 bulbs at 0.77 W/m²/nm at 340 nm) at 60° C. and condensation at 50° C.

All panels were visually evaluated after 168 hours of alternating exposure to fluorescent UV and condensation. The scribed polymer/primer panels showed 1/16 inch creepage and less than 1% surface area rust. Unscribed polymer/primer panels showed no surface rust. The polymer/primer/enamel top-coated panels showed no sign of corrosion or discoloration.

All test panels were then subjected to 168 hours of salt fog/drying consisting of alternating every hour between exposure to a salt fog (dilute electrolyte solution of 0.05% sodium chloride and 0.35% ammonium sulfate) at ambient temperature and drying at 35° C.

After 168 hours of salt fog/drying, all panels were visually re-evaluated. All polymer/primer panels (both scribed and unscribed) showed greater than 90% surface rust. For all polymer/primer panels, most of the primer coating flaked off during the testing. Where small pieces of primer coating remained, no rust was noted. The polymer/primer/enamel panels showed no sign of corrosion or discoloration.

### Example 2

### Cyclic Corrosion Testing of Test Panels Coated with Cross-Linked Polymer (From 2:1 Cross-Linkable Hydrolyzed Polymer:Cross Linking Agent)

Sixteen additional 1010 cold-rolled steel test panels (ten of which were prepared with 50% cross-linked polymer base coating) were prepared for cyclic corrosion testing.

Ten of the sixteen test panels were first coated with a cross-linked polymer base coat by dipping into a cross-linked polymer made from HEVA (dissolved in toluene at about 10% HEVA by weight) and Desmodur® L 75 (an aromatic polyisocyanate cross linking agent by Bayer Material Science) at about a 2:1 ratio by weight, and allowed to dry.

Four of the polymer coated panels were tested without further coating. Two of the polymer coated panels were further dipped twice in Red Oxide primer III (Zinc Rich), with each dipping being conducted at about 15 minutes apart. Two of the polymer coated panels were further dipped twice in a Olive Drab Green enamel top coat (again at about 15 minutes apart). Two of the polymer coated panels were further dipped twice in a Desert Sand enamel top coat (also at about 15 minutes apart).

Of the remaining six panels (those not coated with the cross-linked polymer), two were dipped twice in Red Oxide primer III (Zinc Rich), two were dipped twice in Olive Drab Green enamel, and two dipped twice in a Desert Sand enamel. As above, all panels that were dipped more than once were dipped at about 15 minutes apart.

Preparation details for all evaluated test panels are presented in Table 1.

TABLE 1
Test Panel Preparation (2:1 by weight cross-
linkable polymer:cross linking agent)

| Test | HEVA-12 | Desert | OD | Red Oxide Primer |
|---|---|---|---|---|
| Panel | (50%) | Sand | Green | III Zinc Rich |
| 4-1 | X | X | | |
| 4-2 | X | X | | |
| 5-1 | X | | X | |
| 5-2 | X | | X | |
| 6-1 | X | | | X |
| 6-2 | X | | | X |
| 7-1 | X | | | |
| 7-2 | X | | | |
| 7-3 | X | | | |
| 7-4 | X | | | |
| 8-1 | | | X | |
| 8-2 | | | X | |
| 9-1 | | X | | |
| 9-2 | | X | | |
| 10-1 | | | | X |
| 10-2 | | | | X |

Cyclic exposure testing was conducted according to ASTM D5894-05, Standard Practice for Cyclic Salt Fog/UV Exposure of Painted Metal, (Alternating Exposures in a Fog/Dry Cabinet and a UV/Condensation Cabinet). All panels were diagonally scribed and subjected to three cycles of fluorescent UV/condensation and salt fog/drying. At various times during the three cycles, the test panels were evaluated for surface corrosion (per ASTM D610-01, Standard Test Method for Evaluating Degree of Rusting on Painted Steel Surfaces), blistering (per ASTM D714-02, Standard Test Method for Evaluating Degree of Blistering of Paints), and creep from scribe (per ATSM D1654-05, Standard Test Method for Evaluation of Painted or Coated Specimens Subjected to Corrosive Environments). The scale of Rust Rating according to ASTM D610-01 is presented above in Table 2.

TABLE 2
Scale of Rust Rating per ASTM D610-01

| Rust Grade | Percent of Surface Rust (Rₛ) |
|---|---|
| 10 | Rₛ ≦ 0.01% |
| 9 | 0.01% < Rₛ ≦ 0.03% |
| 8 | 0.03% < Rₛ ≦ 0.10% |
| 7 | 0.10% < Rₛ ≦ 0.30% |
| 6 | 0.30% < Rₛ ≦ 1.00% |
| 5 | 1.00% < Rₛ ≦ 3.00% |
| 4 | 3.00% < Rₛ ≦ 10.0% |
| 3 | 10.0% < Rₛ ≦ 16.0% |
| 2 | 16.0% < Rₛ ≦ 33.0% |
| 1 | 33.0% < Rₛ ≦ 50.0% |
| 0 | 50.0% < Rₛ |

The test panels were first subjected to 168 hours of fluorescent UV/condensation cycling consisting of alternating every four hours between exposure to UV light (UVA 340 bulbs at 0.89 W/m²/nm at 340 nm) at 60° C., and condensation at 50° C.±3° C.

The test panels were then subjected to 168 hours of salt fog/drying cycling consisting of alternating every hour between exposure to a salt fog (dilute electrolyte solution of 0.05% sodium chloride and 0.35% ammonium sulfate) at ambient temperature, and drying time at 35° C.

Completion of 168 hours of fluorescent UV/condensation cycling and 168 hours of salt fog/drying cycling constituted on test cycle. This test cycle was repeated twice, for a total of three test cycles. Test panels were evaluated for corrosion, creep from scribe, and blister rating at the end of each half test cycle. Data from these evaluations are presented in Tables 3-8.

TABLE 3
Middle of Cycle 1 (168 hours UV/condensation
cycling and 0 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | 10 | <1 | None |
| 4-2 | 10 | <1 | None |
| 5-1 | 10 | 0 | None |
| 5-2 | 10 | 0 | None |
| 6-1 | 10 | 0 | None |
| 6-2 | 10 | 0 | None |
| 7-1 | 10 | 0 | None |
| 7-2 | 10 | 0 | None |
| 7-3 | 9P* | <1 | None |
| 7-4 | 9P* | <1 | None |
| 8-1 | 7G* | 0 | None |
| 8-2 | 7G* | 0 | None |
| 9-1 | 7P* | 0 | None |
| 9-2 | 6P* | 0 | None |
| 10-1 | 10 | 0 | None |
| 10-2 | 10 | 0 | None |

*G = general rusting
*P = pinpoint rusting

TABLE 4
End of Cycle 1 (168 hours UV/condensation
cycling and 168 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | 10 | 2.2 | None |
| 4-2 | 10 | 3.1 | None |
| 5-1 | 10 | 3.3 | None |
| 5-2 | 10 | 2.1 | None |
| 6-1 | 10 | 3.4 | None |
| 6-2 | 10 | 1.6 | None |
| 7-1 | 10 | 1.8 | None |
| 7-2 | 10 | 2.4 | None |
| 7-3 | 6S* | 3.6 | None |
| 7-4 | 6S* | 3.2 | None |
| 8-1 | 5G* | <1 | #6 med. |
| 8-2 | 5G* | 0 | #6 few |
| 9-1 | 4P* | 0 | #6 med. |
| 9-2 | 4P* | 0 | #6 med. |
| 10-1 | 10 | <1 | None |
| 10-2 | 10 | 1.1 | None |

*S = spot rusting
*G = general rusting
*P = pinpoint rusting

TABLE 5
Middle of Cycle 2 (336 hours UV/condensation
cycling and 168 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | 10 | 2.0 | None |
| 4-2 | 10 | 4.3 | None |
| 5-1 | 10 | 0 | None |
| 5-2 | 10 | 0 | None |
| 6-1 | 10 | 0 | None |
| 6-2 | 10 | 0 | None |
| 7-1 | 10 | 3.0 | None |
| 7-2 | 10 | 3.3 | None |
| 7-3 | 6S* | 4.4 | None |
| 7-4 | 6S* | 4.3 | None |
| 8-1 | 5G* | 0 | #6 few |
| 8-2 | 5G* | 0 | #6 few |
| 9-1 | 4P* | 0 | #6 dense |
| 9-2 | 5P* | 0 | #6 dense |
| 10-1 | 10 | <1 | None |
| 10-2 | 10 | 1.6 | None |

*S = spot rusting
*G = general rusting
*P = pinpoint rusting

TABLE 6
End of Cycle 2 (336 hours UV/condensation
cycling and 336 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | 10 | 4.7 | None |
| 4-2 | 10 | 4.5 | None |
| 5-1 | 10 | 4.1 | None |
| 5-2 | 10 | 5.5 | None |
| 6-1 | 10 | 4.1 | None |
| 6-2 | 10 | 3.3 | None |
| 7-1 | 10 | 3.0 | None |
| 7-2 | 10 | 4.4 | None |
| 7-3 | 6S* | 5.4 | None |
| 7-4 | 6S* | 5.0 | None |
| 8-1 | 5G* | 1.0 | #6 dense |
| 8-2 | 5G* | 0 | #6 med./dense |
| 9-1 | 4P* | 0 | #6 dense |
| 9-2 | 4P* | 0 | #6 dense |
| 10-1 | 10 | 1.8 | None |
| 10-2 | 10 | 1.9 | None |

*S = spot rusting
*G = general rusting
*P = pinpoint rusting

TABLE 7
Middle of Cycle 3 (504 hours UV/condensation
cycling and 336 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | 9P* | 5.1 | None |
| 4-2 | 10 | 5.4 | None |
| 5-1 | 10 | 5.4 | None |
| 5-2 | 10 | 5.8 | None |
| 6-1 | 10 | 5.4 | None |
| 6-2 | 10 | 4.0 | None |
| 7-1 | 10 | 3.6 | None |
| 7-2 | 10 | 5.2 | None |
| 7-3 | 6S* | 5.8 | None |
| 7-4 | 6S* | 6.1 | None |
| 8-1 | 1G* | 1.8 | #6 dense |
| 8-2 | 0 | 1.0 | #6 med./dense |
| 9-1 | 1G* | 1.0 | #6 dense |
| 9-2 | 1G* | 1.0 | #6 dense |
| 10-1 | 10 | 3.2 | None |
| 10-2 | 3G* | 2.5 | None |

*S = spot rusting
*G = general rusting
*P = pinpoint rusting

TABLE 8
End of Cycle 3 (504 hours UV/condensation
cycling and 504 hours salt fog/drying)

| | | Creep from Scribe | |
|---|---|---|---|
| Test | Corrosion Grade | (mm) | Blister Rating |
| Panel | (ASTM D1654-05) | (ASTM D1654-05) | (ASTM D714-02) |
| 4-1 | NA | Total Failure¹ | NA |
| 4-2 | 10 | 7.5 | None |
| 5-1 | NA | Total Failure¹ | NA |
| 5-2 | NA | Total Failure¹ | NA |
| 6-1 | 10 | 8.0 | None |
| 6-2 | 10 | 7.0 | None |
| 7-1 | 10 | 4.7 | None |
| 7-2 | NA | Total Failure¹ | NA |
| 7-3 | 6S* | 16.5 | None |
| 7-4 | NA | Total Failure¹ | NA |
| 8-1 | NA | Total Failure¹ | NA |
| 8-2 | 5G* | 2.0 | #6 med./dense |
| 9-1 | NA | Total Failure¹ | NA |
| 9-2 | NA | Total Failure¹ | NA |
| 10-1 | 10 | 2.9 | None |
| 10-2 | NA | Total Failure¹ | NA |

¹Total Failure = Creep reached edge of test panel
*S = spot rusting
*G = general rusting

### Example 3

### Cyclic Corrosion Testing of Test Panels Coated with Cross-Linked Polymer (From 4:1 Cross-Linkable Hydrolyzed Polymer:Cross Linking Agent)

Twenty two additional 1010 cold-rolled steel test panels (eighteen of which were prepared with 25% cross-linked polymer base coating) were prepared for cyclic corrosion testing.

Eighteen of the twenty two test panels were first coated with a cross-linked polymer base coat by dipping into a cross-linked polymer made from HEVA (dissolved in toluene at about 10% HEVA by weight) and Desmodur® L 75 (an aromatic polyisocynate cross linking agent by Bayer Material Science) at about a 4:1 ratio by weight, and allowed to dry.

Six of the polymer coated panels were tested without additional coating. Of these six, two were prepared with a single dip in the polymer; two were prepared with two dips in the cross-linked polymer; and two were prepared with three dips in the polymer (with about 15 minutes between dips in the cross-linked polymer).

All of the remaining twelve polymer coated panels were prepared with two dips in the polymer coating (about 15 minutes apart), followed by coating with one or more additional materials. For all panels with multiple dips in one or more additional materials, successive dips were about 15 minutes apart.

Four of the polymer coated panels were further dipped twice in Red Oxide primer III (Zinc Rich) with no additional top coating.

Two of the polymer coated panels were further dipped twice in Red Oxide primer III (Zinc Rich) and dipped twice in an Olive Drab Green enamel top coat.

Two of the polymer coated panels were further dipped twice in Red Oxide primer III (Zinc Rich) and dipped twice in a Bridge Paint enamel top coat.

Two of the polymer coated panels were further dipped twice in an Olive Drab Green enamel top coat (without the intermediate primer).

Two of the polymer coated panels were further dipped twice in a Bridge Paint enamel top coat (without the intermediate primer).

Of the remaining four panels (those not coated with cross-linked polymer), two were dipped twice in Red Oxide primer III (Zinc Rich) and dipped twice in Olive Drab Green enamel, two were dipped twice in Red Oxide primer III (Zinc Rich) and dipped twice in Bridge Paint enamel.

Preparation details for all evaluated test panels are presented in Table 9.

TABLE 9
Test Panel Preparation (4:1 by weight cross-
linkable polymer:cross linking agent)

| | Polymer | | | Red Oxide Primer | Semi Gloss | |
|---|---|---|---|---|---|---|
| | (25% cross-linked) | | | III Zinc | (Olive Drab | |
| Test | Coating Dips | | | Rich 2 Coats | Green) 2 Coats | Bridge |
| Panel | 1 | 2 | 3 | (Lt. & Heavy) | (Lt. & Heavy) | Paint |
| 1* | | | X | | | |
| 2 | | | X | | | |
| 3* | X | | | | | |
| 4 | X | | | | | |
| 5 | | X | | X | | |
| 6 | | X | | X | | |
| 7 | | X | | X | X | |
| 8 | | X | | X | X | |
| 9* | | X | | X (same as | | |
| | | | | 5 & 6) | | |
| 10* | | X | | X (same as | | |
| | | | | 5 & 6) | | |
| 11 | | X | | X | | X |
| 12 | | X | | X | | X |
| 13* | | X | | | | |
| 14 | | X | | | | |
| 15 | | | | X | X | |
| 16 | | | | X | X | |
| 17 | | | | X | | X |
| 18 | | | | X | | X |
| 19 | | X | | | X | |
| 20 | | X | | | X | |
| 21 | | X | | | | X |
| 22 | | X | | | | X |

*Plates intentionally scratched prior to testing.

Cyclic exposure testing was conducted according to ASTM D5894-05, Standard Practice for Cyclic Salt Fog/UV Exposure of Painted Metal, (Alternating Exposures in a Fog/Dry Cabinet and a UV/Condensation Cabinet). Panels 1, 3, 9, 10, and 13 were diagonally scribed prior to exposure testing. All test panels were subjected to three cycles of fluorescent UV/condensation and salt fog/drying. At various times during the three cycles, the test panels were visually evaluated for surface corrosion (per ASTM D610-01, Standard Test Method for Evaluating Degree of Rusting on Painted Steel Surfaces), blistering (per ASTM D714-02, Standard Test Method for Evaluating Degree of Blistering of Paints), and creep from scribe (per ATSM D1654-05, Standard Test Method for Evaluation of Painted or Coated Specimens Subjected to Corrosive Environments). The scale of Rust Rating according to ASTM D610-01 is presented above in Table 2.

All test panels were first subjected to 168 hours of fluorescent UV/condensation consisting of alternating every four hours between exposure to UV light (UVA 340 bulbs at 0.89 W/m²/nm at 340 nm) at 60° C. and condensation at 50° C.±3° C.

All test panels were then subjected to 168 hours of salt fog/drying consisting of alternating every hour between exposure to a salt fog (dilute electrolyte solution of 0.05% sodium chloride and 0.35% ammonium sulfate) at ambient temperature and drying at 35° C.

Completion of 168 hours of fluorescent UV/condensation and 168 hours of salt fog/drying constituted one test cycle. This test cycle was repeated twice, for a total of three test cycles. Test panels were visually evaluated at the end of the first test cycle, and every half-cycle thereafter. Results of these evaluations are presented in Tables 10-14.

TABLE 10
End of Cycle 1 (168 hours UV/condensation
and 168 hours salt fog/drying)

| | Corrosion | Creep from | Blister | |
|---|---|---|---|---|
| | Grade | Scribe (mm) | Rating | |
| Test | (ASTM | (ASTM | (ASTM | Additional |
| Panel | D1654-05) | D1654-05) | D714-02) | Comments |
| 1 | 10 | 0.89 (Rust Swell) | None | |
| 2 | 10 | — | None | |
| 3 | 10 | 0.76 (Rust Swell) | None | |
| 4 | 10 | — | None | |
| 5 | 10 | — | None | |
| 6 | 10 | — | None | |
| 7 | 10 | — | None | |
| 8 | 10 | — | None | |
| 9 | 10 | 2.92 (Rust Swell) | None | |
| 10 | 10 | 2.92 (Rust Swell) | None | |
| 11 | 10 | — | None | |
| 12 | 10 | — | None | |
| 13 | 10 | 1.07 (Rust Swell) | None | |
| 14 | 10 | — | None | |
| 15 | 10 | — | None | |
| 16 | 10 | — | None | |
| 17 | 10 | — | None | Paint Cracking |
| 18 | 10 | — | None | Paint Cracking |
| 19 | 7 | — | None | |
| 20 | 7 | — | None | |
| 21 | 10 | — | None | |
| 22 | 10 | — | None | |

TABLE 11
Middle of Cycle 2 (336 hours UV/condensation
and 168 hours salt fog/drying)

| | Corrosion | Creep from | Blister | |
|---|---|---|---|---|
| | Grade | Scribe (mm) | Rating | |
| Test | (ASTM | (ASTM | (ASTM | Additional |
| Panel | D1654-05) | D1654-05) | D714-02) | Comments |
| 1 | 9 | 2.90 (Rust Swell) | None | Severe Yellowing |
| 2 | 9 | NA | None | Severe Yellowing |
| 3 | 5 | 3.89 (Rust Swell) | #6 med. | |
| | | | dense | |
| 4 | 6 | NA | #6 med. | |
| 5 | 10 | NA | None | Slight Fading |
| 6 | 10 | NA | None | Slight Fading |
| 7 | 10 | NA | None | Slight Fading |
| 8 | 10 | NA | None | Slight Fading |
| 9 | 10 | 5.54 | None | Slight Fading |
| 10 | 10 | 4.17 | None | Slight Fading |
| 11 | 10 | NA | None | |
| 12 | 10 | NA | None | |
| 13 | 8 | 4.85 (Rust Swell) | #6 few | Moderate |
| | | | | Yellowing |
| 14 | 8 | NA | #6 few | Moderate |
| | | | | Yellowing |
| 15 | 9 | NA | #6 few | Slight Fading |
| 16 | 9 | NA | None | Slight Fading |
| 17 | 8 | NA | #6 few | Paint Cracking |
| 18 | 8 | NA | None | Paint Cracking |
| 19 | 6 | NA | None | Severe Yellowing |
| 20 | 6 | NA | None | Severe Yellowing |
| 21 | 10 | NA | #4 few | |
| 22 | 10 | NA | #6 few | |

TABLE 12
End of Cycle 2 (336 hours UV/condensation
and 336 hours salt fog/drying)

| | Corrosion | Creep from | Blister | |
|---|---|---|---|---|
| | Grade | Scribe (mm) | Rating | |
| Test | (ASTM | (ASTM | (ASTM | Additional |
| Panel | D1654-05) | D1654-05) | D714-02) | Comments |
| 1 | 9 | 4.06 (Rust Swell) | None | Severe Yellowing |
| 2 | 9 | NA | None | Severe Yellowing |
| 3 | 5 | 3.89 (Rust Swell) | #6 med. | Slight Yellowing |
| | | | dense | |
| 4 | 5 | NA | #6 med. | Slight Yellowing |
| 5 | 10 | NA | None | Slight Fading |
| 6 | 10 | NA | None | Slight Fading |
| 7 | 10 | NA | None | Slight Fading |
| 8 | 10 | NA | None | Slight Fading |
| 9 | 10 | 5.54 | None | Slight Fading |
| 10 | 10 | 5.44 | None | Slight Fading |
| 11 | 10 | NA | None | |
| 12 | 9 | NA | None | 1 Red Rust Pit |
| 13 | 8 | 4.85 (Rust Swell) | #6 few | Moderate |
| | | | | Yellowing |
| 14 | 8 | NA | #6 few | Moderate |
| | | | | Yellowing |
| 15 | 9 | NA | #6 few | Slight Fading |
| 16 | 9 | NA | #6 few | Slight Fading |
| 17 | 8 | NA | #6 few | Paint Cracking |
| 18 | 8 | NA | None | Paint Cracking |
| 19 | 6 | NA | None | Severe Yellowing |
| 20 | 6 | NA | None | Severe Yellowing |
| 21 | 10 | NA | #4 few | |
| 22 | 10 | NA | #6 few | |

TABLE 13
Middle of Cycle 3 (504 hours UV/condensation
and 336 hours salt fog/drying)

| | Corrosion | Creep from | Blister | |
|---|---|---|---|---|
| | Grade | Scribe (mm) | Rating | |
| Test | (ASTM | (ASTM | (ASTM | Additional |
| Panel | D1654-05) | D1654-05) | D714-02) | Comments |
| 1 | 9 | 6.81 (Rust Swell) | #8 few | Severe Yellowing |
| 2 | 9 | NA | #8 few | Severe Yellowing |
| 3 | 4 | 5.84 (Rust Swell) | #6 med. | Slight Yellowing |
| | | | dense | |
| 4 | 5 | NA | #6 med. | Slight Yellowing |
| 5 | 10 | NA | None | Moderate Fading |
| 6 | 10 | NA | None | Moderate Fading |
| 7 | 10 | NA | #8 few | Slight Fading/ |
| | | | | 1 Blister |
| 8 | 10 | NA | None | Slight Fading |
| 9 | 10 | 8.03 | None | Moderate Fading |
| 10 | 10 | 6.48 | None | Moderate Fading |
| 11 | 10 | NA | None | Slight Fading |
| 12 | 9 | NA | None | Slight Fading/ |
| | | | | 1 Red Rust Pit |
| 13 | 6 | 6.45 (Rust Swell) | #6 few | Severe Yellowing |
| 14 | 8 | NA | #6 few | Severe Yellowing |
| 15 | 8 | NA | #6 med. | Slight Fading |
| 16 | 9 | NA | #6 few | Slight Fading |
| 17 | 8 | NA | #6 few | Slight Fading/ |
| | | | | Paint Cracking |
| 18 | 8 | NA | #6 few | Paint Cracking |
| 19 | 6 | NA | None | Severe Yellowing |
| 20 | 6 | NA | None | Severe Yellowing |
| 21 | 10 | NA | #4 few | |
| 22 | 10 | NA | #6 few | |

TABLE 14
End of Cycle 3 (504 hours UV/condensation
and 504 hours salt fog/drying)

| | Corrosion | Creep from | Blister | |
|---|---|---|---|---|
| | Grade | Scribe (mm) | Rating | |
| Test | (ASTM | (ASTM | (ASTM | Additional |
| Panel | D1654-05) | D1654-05) | D714-02) | Comments |
| 1 | 0 | 10.54 | #8 few | Severe Yellowing |
| 2 | 3 | NA | #8 few | Severe Yellowing |
| 3 | 0 | 6.86 | #6 med. | Slight Yellowing |
| | | | dense | |
| 4 | 0 | NA | #6 med. | Slight Yellowing |
| 5 | 10 | NA | None | Moderate Fading |
| 6 | 10 | NA | None | Moderate Fading |
| 7 | 10 | NA | #8 few | Slight Fading/ |
| | | | | 1 Blister |
| 8 | 10 | NA | None | Slight Fading |
| 9 | 10 | 8.03 | None | Moderate Fading |
| 10 | 10 | 6.48 | None | Moderate Fading |
| 11 | 10 | NA | None | Slight Fading |
| 12 | 9 | NA | None | Slight Fading/ |
| | | | | 1 Red Rust Pit |
| 13 | 0 | 11.58 | #6 few | Severe Yellowing |
| 14 | 0 | NA | #6 dense | Severe Yellowing |
| 15 | 8 | NA | #6 med. | Slight Fading |
| 16 | 9 | NA | #6 few | Slight Fading |
| 17 | 7 | NA | #6 med. | Slight Fading/ |
| | | | | Paint Cracking |
| 18 | 8 | NA | #6 few | Paint Cracking |
| 19 | 0 | NA | None | Severe Yellowing |
| 20 | 0 | NA | None | Severe Yellowing |
| 21 | 10 | NA | #4 few | |
| 22 | 10 | NA | #6 few | |

### Example 4

### Polymer Adhesion as a Function of Cross-Linking

As reflected by the corrosion grade, creep from scribe, and blistering data shown above, polymer adhesion (as reflected in corrosion resistance) is increased for cross-linked polymers prepared from mixtures of cross-linkable hydrolysable polymer to cross linking agent at ratios greater than 1:1 cross-linkable polymer:cross linking agent. For example, a comparison of corrosion grade data for polymer/primer coated samples demonstrates that increasing cross-linkable polymer: cross linking agent ratio (by weight) from 1:1 to about 2:1 or 4:1 enhances the corrosion resistance.

Further, an improvement in corrosion resistance is seen going from 2:1 by weight to 4:1 by weight cross-linkable polymer:cross linking agent. Data from crossed-linked polymer coatings prepared from mixtures at 1:1, 2:1, and 4:1 by weight are compiled in Table 15 for comparison. Data demonstrating the improvement in corrosion resistance seen in the 2:1 and 4:1 uncoated and OD-enamel coated panels are seen in Tables 16 and 17, respectively.

TABLE 15
Corrosion resistance of polymer/primer samples coated with
cross-linked polymers from mixtures of 1:1, 2:1, and 4:1
(by weight) cross-linkable polymer:cross linking agent

| Poly/Primer | | | | | |
|---|---|---|---|---|---|
| Ratio of polymer: | Average Corrosion Grade | | | | |
| cross-linking agent | 1 | 1.5 | 2 | 2.5 | 3 |
| (by weight) | cycle | cycles | cycles | cycles | cycles |
| 1:1 | 0 | n/a | n/a | n/a | n/a |
| 2:1 | 10 | 10 | 10 | 10 | 10 |
| 4:1 | 10 | 10 | 10 | 10 | 10 |

TABLE 16
Corrosion resistance of polymer only samples coated with
cross-linked polymers from mixtures of 2:1 and 4:1 (by
weight) cross-linkable polymer:cross linking agent

| Poly Only | | | | | |
|---|---|---|---|---|---|
| Ratio of polymer: | Average Corrosion Grade | | | | |
| cross-linking agent | 1 | 1.5 | 2 | 2.5 | 3 |
| (by weight) | cycle | cycles | cycles | cycles | cycles |
| 2:1 (2 dip) | 8 | 8 | 8 | 8 | 8 |
| 4:1 (1 dips) | 10 | 5.5 | 5 | 4.5 | 0 |
| 4:1 (2 dips) | 10 | 8 | 8 | 7 | 0 |
| 4:1 (3 dips) | 10 | 9 | 9 | 9 | 1.5 |

TABLE 17
Corrosion resistance of polymer/OD enamel samples coated
with cross-linked polymers from mixtures of 2:1 and 4:1
(by weight) cross-linkable polymer:cross linking agent

| Poly/OD Enamel | | | | | |
|---|---|---|---|---|---|
| Ratio of polymer: | Average Corrosion Grade | | | | |
| cross-linking agent | 1 | 1.5 | 2 | 2.5 | 3 |
| (by weight) | cycle | cycles | cycles | cycles | cycles |
| 2:1 | 10 | 10 | 10 | 10 | n/a |
| 4:1 | 7 | 6 | 6 | 6 | 0 |

Results observed with respect to creep from scribe measurement indicate that cross-linked polymer coatings from mixtures of 2:1 by weight cross-linkable polymer:cross linking agent performed slightly better cross-linked polymer coatings from than mixtures of 4:1 by weight cross-linkable polymer:cross linking agent.

Blister data from cross-linked coated panels were roughly equivalent from both the 2:1 and 4:1 preparations. Compiled results are presented in Tables 18-20.

TABLE 18
Blistering rating of polymer/primer samples with
coatings from 2:1 and 4:1 by weight cross-linkable
polymer:cross linking agent mixtures.

| Poly/Primer | | | | | |
|---|---|---|---|---|---|
| Ratio of polymer: | Blistering Rating | | | | |
| cross-linking agent | 1 | 1.5 | 2 | 2.5 | 3 |
| (by weight) | cycle | cycles | cycles | cycles | cycles |
| 2:1 | none | none | none | None | none |
| 4:1 | none | none | none | None | none |

TABLE 19
Blistering rating of polymer only samples with coatings from 2:1 and
4:1 by weight cross-linkable polymer:cross linking agent mixtures.

| Poly Only | | | | | |
|---|---|---|---|---|---|
| Ratio of polymer: | Blistering Rating | | | | |
| cross-linking agent | 1 | 1.5 | 2 | 2.5 | 3 |
| (by weight) | cycle | cycles | cycles | cycles | cycles |
| 2:1 | none | none | none | none | n/a |
| 4:1 | none | #6 few | #6 few | #6 few | #6 few/dense |

TABLE 20
Blistering rating of polymer/OD enamel samples
with coatings from 2:1 and 4:1 by weight cross-
linkable polymer:cross linking agent mixtures

| Poly/OD Enamel | | | | | |
|---|---|---|---|---|---|
| Ratio of polymer: | Blistering Rating | | | | |
| cross-linking agent | 1 | 1.5 | 2 | 2.5 | 3 |
| (by weight) | cycle | cycles | cycles | cycles | cycles |
| 2:1 | none | none | none | none | none |
| 4:1 | none | none | none | none | none |

### Example 5

### Moisture Impermeability as a Function of Cross-Linking

Thin films prepared according to various embodiments described herein were tested to determine their water vapor transmission rate as a measure of their water permeance. Water vapor transmission testing was conducted according to ASTM E96-05, Standard Test Methods for Water Vapor Transmission of Materials (Procedure A with desiccant method). Procedure A is the standard test performed for materials; it is conducted under standard conditions of 73.4° F. (or 23° C.), with a relative humidity of 50%.

All samples were prepared with an exposed area sealed to test cups containing approximately 80 grams of desiccant. Wax was used to seal the samples to the cup and prevent transmission around the edges of the sample. Three samples were tested for each material. Results of these tests are reported below, in Table 21, as average results from each sample type.

TABLE 21
Water Vapor Transmission Testing Results

| | | H₂O Vapor | | | |
|---|---|---|---|---|---|
| Composition | Thick- | Transmission Rate | | Permeance | |
| (and % | ness | (g/ | (grains/ | (g/ | |
| cross-linking) | (mils) | h*m²) | h*ft²) | Pa*s*m²) | (perms) |
| HEVA @ 25% | 1.4 | 0.61 | 0.87 | 1.21 × 10⁻⁷ | 2.10 |
| | 1.5 | 0.81 | 1.16 | 1.61 × 10⁻⁷ | 2.79 |
| | 1.6 | 0.85 | 1.22 | 1.69 × 10⁻⁷ | 2.94 |
| | 1.8 | 0.53 | 0.75 | 1.04 × 10⁻⁷ | 1.82 |
| | 1.8 | 0.56 | 0.81 | 1.12 × 10⁻⁷ | 1.94 |
| | 1.8 | 0.73 | 1.05 | 1.45 × 10⁻⁷ | 2.52 |
| | 1.9 | 0.54 | 0.76 | 1.06 × 10⁻⁷ | 1.84 |
| | 6.6 | 0.19 | 0.27 | 3.77 × 10⁻⁸ | 0.66 |
| | 7.0 | 0.16 | 0.24 | 3.26 × 10⁻⁸ | 0.57 |
| | 7.4 | 0.19 | 0.27 | 3.68 × 10⁻⁸ | 0.64 |
| | 8.6 | 0.14 | 0.20 | 2.79 × 10⁻⁸ | 0.49 |
| | 10.7 | 0.11 | 0.16 | 2.23 × 10⁻⁸ | 0.39 |
| | 10.7 | 0.13 | 0.19 | 2.60 × 10⁻⁸ | 0.45 |
| | 11.2 | 0.12 | 0.18 | 2.43 × 10⁻⁸ | 0.42 |
| | 12.0 | 0.15 | 0.21 | 2.89 × 10⁻⁸ | 0.50 |
| | 12.6 | 0.10 | 0.15 | 2.07 × 10⁻⁸ | 0.36 |
| HEVA-12 @ | 6.5 | 0.29 | 0.41 | 5.78 × 10⁻⁸ | 1.01 |
| 25% | | | | | |
| | 6.8 | 0.27 | 0.39 | 5.30 × 10⁻⁸ | 0.92 |
| | 6.8 | 0.25 | 0.36 | 5.01 × 10⁻⁸ | 0.87 |
| HEVA-12 @ | 15.9 | 0.04 | 0.06 | 8.60 × 10⁻⁹ | 0.15 |
| 50% | | | | | |
| | 26.0 | 0.04 | 0.06 | 8.95 × 10⁻⁹ | 0.16 |
| HEVA-12 @ | 18.9 | 0.05 | 0.07 | 9.44 × 10⁻⁹ | 0.16 |
| 75% | | | | | |
| | 30.8 | 0.03 | 0.05 | 6.72 × 10⁻⁹ | 0.12 |
| HEVA-12 @ | 16.7 | 0.05 | 0.07 | 9.67 × 10⁻⁹ | 0.17 |
| 100% | | | | | |
| | 32.4 | 0.03 | 0.04 | 5.64 × 10⁻⁹ | 0.10 |

### Example 6

### Adhesion Performance

Adhesion is the ability of a coating to be continuously attached the object upon which it is applied throughout its normal service life. Thin films prepared according to various embodiments described herein were tested to determine their adhesion characteristics. Adhesion testing was conducted according to ASTM D4541, Standard Method for Pull-Off Strength of Coatings Using Portable Adhesion Testers. Adhesion is measured as the force per square inch required to pull a coating off of a metal panel's surface and is expressed as pounds per square inch (psi).

Embodiments of the present invention were measured to have adhesion pull-off strengths in the range of about 1870 to about 2050 psi.

What is claimed is:

1. A composition for preparing a corrosion resistant coating for a bulk substrate, said composition comprising:
a cross-linkable hydrolyzed polymer; and
a cross-linking agent,
wherein the cross-linking agent is present in an amount sufficient to cross link about 21.8% to 65.4% of the crosslinkable groups in the cross-linkable hydrolyzed polymer.

2. The composition of claim 1, wherein the cross-linkable hydrolyzed polymer comprises a polymer with a dielectric constant less than about 2.2.

3. The composition of claim 1, wherein the cross-linkable hydrolyzed polymer comprises a hydrolyzable, cross-linkable ethylene-vinyl acetate copolymer.

4. The composition of claim 1, wherein the cross-linkable hydrolyzed polymer comprises partially hydrolyzed poly(ethylene-vinyl acetate).

5. The composition of claim 4, wherein the partially hydrolyzed poly(ethylene-vinyl acetate) comprises about 60 to about 88 mol percent ethylene.

6. The composition of claim 4, wherein the partially hydrolyzed poly(ethylene-vinyl acetate) is about 38 to about 55 percent hydrolyzed.

7. The composition of claim 4, wherein the partially hydrolyzed poly(ethylene-vinyl acetate) is about 44 to about 46 percent hydrolyzed.

8. The composition of claim 5, wherein the partially hydrolyzed poly(ethylene-vinyl acetate) comprises about 70 percent ethylene, about 10 to about 14 percent vinyl alcohol, and about 16 to about 20 percent vinyl acetate.

9. The composition of claim 8, wherein the partially hydrolyzed poly(ethylene-vinyl acetate) comprises about 12.5 to about 13 percent vinyl alcohol.

10. The composition of claim 8, wherein the partially hydrolyzed poly(ethylene-vinyl acetate) comprises about 17 to about 18 percent vinyl acetate.

11. The composition of claim 4, wherein the partially hydrolyzed poly(ethylene-vinyl acetate) comprises vinyl alcohol groups and vinyl acetate groups at a mol ratio of vinyl alcohol groups to the sum of vinyl alcohol groups and the vinyl acetate groups at about 0.15 to about 0.7.

12. The composition of claim 1, wherein the cross-linkable hydrolyzed polymer comprises a poly(vinyl-formal) polymer, a poly(vinyl-butyral) polymer, an alkylated cellulose, or an acylated cellulose.

13. The composition of claim 12, wherein the cross-linkable hydrolyzed polymer comprises ethyl cellulose.

14. The composition of claim 12, wherein the cross-linkable hydrolyzed polymer comprises cellulose acetate butyrate.

15. The composition of claim 1, wherein the cross-linking agent comprises one or more of a diisocyanate and polyisocyanate, with or without a catalyst present.

16. The composition of claim 1, wherein the cross-linking agent comprises a toluene diisocyanate.

17. The composition of claim 1, wherein the cross-linking agent comprises a toluene diisocyanate-trimethylol propane adduct.

18. The composition of claim 1, wherein the cross-linking agent comprises a diacid halide.

19. The composition of claim 18, wherein the diacid halide comprises one or more selected from the group consisting of sulfonyl chloride and a dicarboxylic acid chloride.

20. The composition of claim 1, wherein the cross-linking agent comprises a difunctional hydride.

21. The composition of claim 1, wherein the cross-linkable hydrolyzed polymer and the cross-linking agent are present at a ratio within the range of about 4:1 to about 4:3 by weight.

22. The composition of claim 1, wherein the cross-linkable hydrolyzed polymer and the cross-linking agent are present at a ratio within the range of about 4:1 to about 2:1 by weight.

23. The composition of claim 1, wherein the cross-linkable groups are hydroxyl and the cross-linking agent is present in an amount sufficient to cross link about 21.8% to 65.4% of the hydroxyl groups in the cross-linked hydrolyzed polymer.

24. The composition of claim 23, wherein the cross-linking agent is present in an amount sufficient to cross link about 21.8% to 43.6% of the hydroxyl groups in the cross-linked hydrolyzed polymer.

25. The composition of claim 1, wherein the coating has a permeance less than about 3.00×10⁻⁷ g/Pa*s*m².

26. The composition of claim 1, wherein the coating has a permeance less than about 1.00×10⁻⁷ g/Pa*s*m².

27. The composition of claim 1, wherein the coating has a permeance less than about 5.00×10⁻⁸ g/Pa*s*m².

28. The composition of claim 1, wherein the coating has a permeance less than about 1.00×10⁻⁸ g/Pa*s*m².

29. The composition of claim 1, wherein the coating has a thickness within the range of about 1 to 33 mils.

30. The composition of claim 1, wherein the coating has a thickness within the range of about 5 to 33 mils.

31. The composition of claim 1, wherein the coating has a thickness within the range of about 15 to 33 mils.

32. A method of inhibiting corrosion of a bulk substrate comprising:
dissolving a cross-linkable hydrolyzed polymer in an organic solvent to generate a cross-linkable hydrolyzed polymer solution;
adding a cross-linking agent to said cross-linkable hydrolyzed polymer solution in an amount sufficient to generate a cross-linked hydrolyzed polymer with about 21.8% to 65.4% cross-linked hydroxyl groups; and
applying said cross-linked hydrolyzed polymer to said bulk substrate.

33. The method of claim 32, wherein the cross-linkable hydrolyzed polymer comprises a polymer with a dielectric constant less than about 2.2.

34. The method of claim 32, wherein the cross-linkable hydrolyzed polymer comprises a hydrolyzable, cross-linkable ethylene-vinyl acetate copolymer.

35. The method of claim 32, wherein the cross-linkable hydrolyzed polymer comprises partially hydrolyzed poly(ethylene-vinyl acetate).

36. The method of claim 35, wherein the partially hydrolyzed poly(ethylene-vinyl acetate) comprises about 60 to about 88 mol percent ethylene.

37. The method of claim 35, wherein the partially hydrolyzed poly(ethylene-vinyl acetate) is about 38 to about 55 percent hydrolyzed.

38. The method of claim 35, wherein the partially hydrolyzed poly(ethylene-vinyl acetate) is about 44 to about 46 percent hydrolyzed.

39. The method of claim 35, wherein the partially hydrolyzed poly(ethylene-vinyl acetate) comprises about 70 percent ethylene, about 10 to about 14 percent vinyl alcohol, and about 16 to about 20 percent vinyl acetate.

40. The method of claim 39, wherein the partially hydrolyzed poly(ethylene-vinyl acetate) comprises about 12.5 to about 13 percent vinyl alcohol.

41. The method of claim 39, wherein the partially hydrolyzed poly(ethylene-vinyl acetate) comprises about 17 to about 18 percent vinyl acetate.

42. The method of claim 35, wherein the partially hydrolyzed poly(ethylene-vinyl acetate) comprises vinyl alcohol groups and vinyl acetate groups at a mol ratio of vinyl alcohol groups to the sum of vinyl alcohol groups and the vinyl acetate groups at about 0.15 to about 0.7.

43. The method of claim 32, wherein the cross-linkable hydrolyzed polymer comprises a poly(vinyl-formal) polymer, a poly(vinyl-butyral) polymer, an alkylated cellulose, or an acylated cellulose.

44. The method of claim 43, wherein the cross-linkable hydrolyzed polymer comprises ethyl cellulose.

45. The method of claim 43, wherein the cross-linkable hydrolyzed polymer comprises cellulose acetate butyrate.

46. The method of claim 32, wherein the cross-linking agent comprises one or more of a diisocyanate and polyisocyanate, with or without a catalyst present.

47. The method of claim 32, wherein the cross-linking agent comprises a toluene diisocyanate.

48. The method of claim 32, wherein the cross-linking agent comprises a toluene diisocyanate-trimethylol propane adduct.

49. The method of claim 32, wherein the cross-linking agent comprises a diacid halide.

50. The method of claim 48, wherein the diacid halide comprises a dicarboxylic acid chloride.

51. The method of claim 32, wherein the cross-linking agent comprises a difunctional hydride.

52. The method of claim 32, wherein the cross-linkable hydrolyzed polymer and the cross-linking agent are present at a ratio within the range of about 4:1 to about 4:3.

53. The method of claim 32, wherein the cross-linkable hydrolyzed polymer and the cross-linking agent are present at a ratio within the range of about 4:1 to about 2:1.

54. The method of claim 32, wherein cross-linking agent is added to said cross-linkable hydrolyzed polymer solution in an amount sufficient to cross link about 21.8% to 43.6% of the hydroxyl groups in the cross-linked hydrolyzed polymer.

55. The method of claim 32, wherein the substrate comprises a metal.

56. The method of claim 32, wherein the step of applying said cross-linked hydrolyzed polymer to said substrate comprises applying two or more coats of said cross-linked hydrolyzed polymer to said substrate.

57. The method of claim 32, the step of applying said cross-linked hydrolyzed polymer to said substrate comprises spraying said cross-linked hydrolyzed polymer on said substrate.

58. The method of claim 32, wherein the applied cross-linked hydrolyzed polymer has a permeance less than about 3.00×10⁻⁷ g/Pa*s*m².

59. The method of claim 32, wherein the applied cross-linked hydrolyzed polymer has a permeance less than about 1.00×10⁻⁷ g/Pa*s*m².

60. The method of claim 32, wherein the applied cross-linked hydrolyzed polymer has a permeance less than about 5.00×10⁻⁸ g/Pa*s*m².

61. The method of claim 32, wherein the applied cross-linked hydrolyzed polymer has a permeance less than about 1.00×10⁻⁸ g/Pa*s*m².

62. The method of claim 32, wherein the applied cross-linked hydrolyzed polymer has a thickness within the range of about 1 to 33 mils.

63. The method of claim 32, wherein the applied cross-linked hydrolyzed polymer has a thickness within the range of about 5 to 33 mils.

64. The method of claim 32, wherein the applied cross-linked hydrolyzed polymer has a thickness within the range of about 15 to 33 mils.

65. A coated bulk substrate, comprising:
a bulk substrate;
a corrosion resistant coating comprising a cross-linked hydrolyzed polymer with about 21.8% to 65.4% cross-linking;
wherein said corrosion resistant coating is in contact with at least a portion of a surface of said bulk substrate.

66. The coated substrate of claim 65, wherein the bulk substrate comprises a metal.

67. The coated substrate of claim 65, wherein the percentage of hydroxyl groups in the cross-linked hydrolyzed polymer that are cross linked is within the range of about 21.8% to 43.6%.

68. The coated substrate of claim 65, wherein the corrosion resistant coating has a permeance less than about 3.00×10⁻⁷ g/Pa*s*m².

69. The coated substrate of claim 65, wherein the corrosion resistant coating has a permeance less than about 1.00×10⁻⁷ g/Pa*s*m².

70. The coated substrate of claim 65, wherein the corrosion resistant coating has a permeance less than about 5.00×10⁻⁸ g/Pa*s*m².

71. The coated substrate of claim 65, wherein the corrosion resistant coating has a permeance less than about 1.00×10⁻⁸ g/Pa*s*m².

72. The coated substrate of claim 65, wherein the corrosion resistant coating has a thickness within the range of about 1 to 33 mils.

73. The coated substrate of claim 65, wherein the corrosion resistant coating has a thickness within the range of about 5 to 33 mils.

74. The coated substrate of claim 65, wherein the corrosion resistant coating has a thickness within the range of about 15 to 33 mils.
